(19) United States
(12) Patent Application Publication
(10) Pub. No.: US 2003/0209963 A1
(43) Pub. Date: Nov. 13, 2003

(54) Lamp assembly and method of manufacture

(75) Inventors: Alex Altgilbers, Sparta, TN (US); Ernest C. Weyhrauch, Cookeville, TN (US)

Correspondence Address: JAMES D. STEVENS, REISING, ETHINGTON, BARNES, KISSELLE, ET AL, P.O. BOX 4390, TROY, MI, 48099, US

(73) Assignee: FEDERAL-MOGUL WORLD WIDE, INC., Southfield, MI

(21) Appl. No.: 10/144,018

(22) Filed: May 13, 2002

(51) Int. Cl. H01J 5/48

(52) U.S. Cl. 313/318.01

(57) ABSTRACT

A lamp assembly having a lamp base and an incandescent or electrodeless gas discharge light source mounted on the lamp base. The light source includes a light-transmissive envelope having a groove extending around the envelope at one end, and this groove is used to retain the envelope in place against a mounting surface of the lamp base. The mounting surface has a plurality of fingers circumferentially spaced about a central insertion axis of the light-transmissive envelope. When the envelope is inserted into the lamp base, the fingers deflect outwardly away from the insertion axis and then return at least partially to be received in the groove of the lamp envelope. The fingers provide a radially, inwardly directed force on the lamp envelope to inhibit relative movement between the envelope and the lamp base.

### TECHNICAL FIELD

The invention relates generally to lamp assemblies and, more particularly, to mounting techniques for gas discharge and other lamps.

### BACKGROUND OF THE INVENTION

Various configurations and arrangements form mounting glass lamp envelopes within a lamp base are known. The configuration disclosed in U.S. Pat. No. 5,572,083 to Antonis et al. comprises attaching a rim or collar to a lamp vessel or envelope using an adhesive. Once attached, the collar can be fastened to a mounting plate using a variety of techniques, such as by using hooks carried on the mounting plate to latch onto a surface of the collar. See also, U.S. Pat. No. 5,130,912 to Friederichs et al.

Cementless base attachment techniques are also known, in particular, for press-sealed incandescent lamp mounting. For example, U.S. Pat. No. 4,752,710 to Devir et al. discloses an electric lamp with an insulating base that uses protruding segments that fit into corresponding recessed portions of the press-sealed base portion of the lamp.

U.S. Pat. No. 5,668,433 to Everest et al. discloses an electrodeless fluorescent lamp having a housing that is used to mechanically hold the lamp vessel and to protect an RF shield coating. The housing can have slits to give it flexibility so that it can hold the vessel even when it expands or contracts.

U.S. Pat. No. 6,268,699 to Woodward et al. disclose an electrodeless lamp mounting in which the lamp has a circumferential projection which fits into a groove in a collar to thereby support the lamp about its midsection.

U.S. Pat. No. 6,084,359 to Hetzel et al. disclose a support for a coil of an electrodeless fluorescent lamp. The coil support includes a number of fingers with projections on their ends to hold the coil in place.

### SUMMARY OF THE INVENTION

A lamp assembly constructed according to the present invention includes a lamp base and light source mounted on the lamp base. The light source comprises a light-transmissive envelope having a groove that is used to retain the envelope in place against a mounting surface of the lamp base. The mounting surface has at least one finger capable of deflecting relative to an insertion axis of the light-transmissive envelope when the envelope is inserted into the lamp base. The finger returns at least partially to be received in the groove of the lamp envelope to inhibit relative movement between the envelope and the lamp base along the insertion axis.

Preferably, the groove extends circumferentially about the envelope at a location proximate a base end of the lamp envelope. Also, the lamp base preferably includes a plurality of the fingers spaced circumferentially around the groove, with each finger having a protrusion extending into the groove to inhibit disengagement of the lamp envelope from the lamp base. The fingers are biased so that the protrusions remain in engagement with the groove and the lamp base can be made from plastic with the resiliency of the plastic providing the desired biasing force on the fingers.

In accordance with another aspect of the invention, there is provided a method of making a lamp assembly. The method includes providing a light source having a light-transmissive envelope and a groove therein, and forming a lamp base having a mounting surface. The mounting surface extends about an insertion axis and includes at least one finger having a protrusion, wherein the finger forms at least a portion of the mounting surface. The light-transmissive envelope is disposed along the insertion axis and toward the lamp base so that, upon contact with the lamp envelope, the finger deflects relative to the axis until the protrusion is received within the groove. The fingers are biased to maintain the protrusion in the groove such that the lamp envelope is inhibited from moving axially relative to the lamp base.

### BRIEF DESCRIPTION OF THE DRAWINGS

Preferred exemplary embodiments of the invention will hereinafter be described in conjunction with the appended drawings, wherein like designations denote like elements, and wherein:

FIG. 1 shows an exploded isometric view of a lamp assembly having a light source and a lamp base constructed according to a first embodiment of the invention;

FIG. 2 shows a cross-sectional view of the light source partially disposed into the lamp base with a drive circuit therein;

FIG. 3 shows a cross-sectional view of the lamp assembly in an assembled state;

FIG. 4 shows a bottom view of the lamp base from FIG. 1; and

FIG. 5 shows an incandescent light source constructed according to a second embodiment of the invention.

### DETAILED DESCRIPTION OF THE PREFERRED EMBODIMENTS

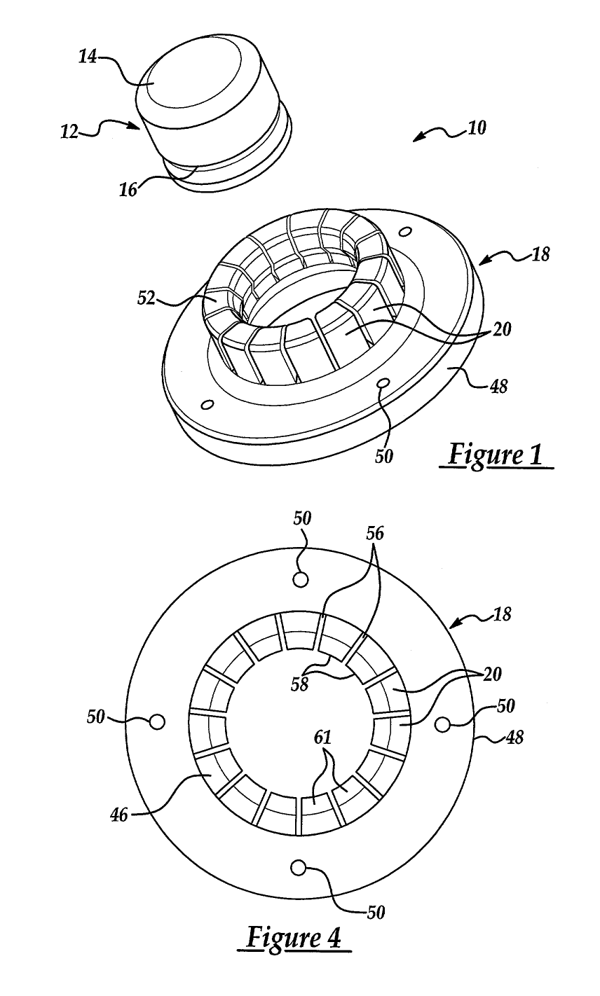

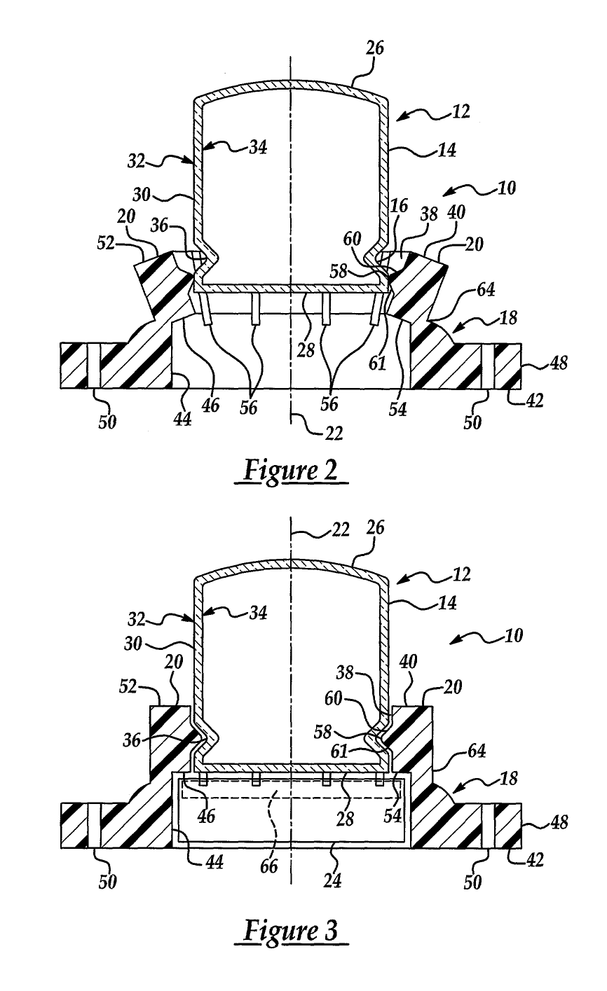

A lamp assembly 10 constructed according to a first embodiment of the invention is indicated generally in FIGS. 1-3 and comprises a light source 12 that has a light-transmissive lamp envelope 14 having a groove 16 therein and a lamp base 18 having fingers 20 that are deflectable to permit insertion and removal of the envelope 14. In the embodiment illustrated in FIGS. 1-3, the light source 12 comprises an electrodeless gas discharge lamp, although it will be appreciated that the invention can be used for incandescent, HID, and other types of light sources. As best shown in FIG. 2, the envelope 14 is inserted into the lamp base 18 along an insertion axis 22 so that the fingers 20 deflect outwardly in response to an initial interference of the envelope 14 with the fingers 20. Continued insertion results in the final mounting of the lamp envelope, as shown in FIG. 3, where the fingers 20 return at least partially to be received in and engage the groove 16 formed on the outer surface of the envelope 14. With the fingers 20 received in the groove 16, the light source 12 is thereby releaseably mounted to the lamp base 18.

The light-transmissive envelope 14 may comprise any suitable type of illumination source, such as a standard filament bulb, or any type of electrodeless gas discharge bulb. The envelope 14 may be fabricated of any of a number of light-transmissive materials, such as gas impervious materials including those commonly used in gas discharge lamp applications, such as quartz, sodium glass or the like.

The light-transmissive envelope 14 has a pair of opposite ends 26, 28 with a generally cylindrical side wall 30 therebetween. It should be recognized that although the envelope 14 is shown here to be generally cylindrical in shape, any suitable geometry could be used for the shape of the envelope 14. The end 28 of envelope 14 that is received within the lamp base 18 is preferably generally flat, while the other end 26 can be shaped to provide the desired illumination effect, shown here as being generally convex. The envelope 14 has an outer surface 32 defining a first diameter that is generally exposed to the atmosphere, and an inner surface 34 that is typically sealed from the atmosphere, especially wherein gases such as neon, xenon, or the like fill the envelope 14.

The groove 16 is preferably located adjacent one of the ends 28 and remotely from the other of the ends 26 of the envelope 14. The groove 16 is shown here to traverse the circumference of the envelope 14, though it should be recognized that it need not do so, nor must it be continuous about the envelope 14. A bottom portion or valley 36 of the groove 16 forms a second diameter, wherein the first diameter defined by the outer surface 32 is generally greater than the second diameter.

As best shown in FIG. 3, the insertion axis 22 of the lamp base 18 extends through an opening defined by a mounting surface 38. The mounting surface 38 has at least one and preferably a plurality of fingers 20 for releaseably mounting the light-transmissive envelope 14 to the lamp base 18. The lamp base 18 has a pair of opposite ends 40, 42 wherein the mounting surface 38 is adjacent one end 40, and a housing 44 having a base surface 46 is adjacent the other end 42. The lamp base 18 preferably has a flange 48 extending from one end 42 wherein the flange 48 preferably has through holes 50 for receiving fasteners (not shown) for mounting the lamp base 18 to another surface (not shown). It should be recognized that any suitable attachment mechanism may be used to fasten the lamp base 18 to another surface, and that the through holes 50 shown as being preferred need not be the only mechanism for attachment.

The fingers 20 have a free end 52 forming one end 40 of the lamp base 18, and another end 54 forming at least a portion of the housing 44, shown here as the base surface 46. The base surface provides a positive stop surface for receiving a drive circuit 24. Each finger 20 has a slit 56 on either side of the finger 20 to enable the fingers 20 to move relative to one another. The slits 56 promote the deflection of the fingers 20 during insertion and removal of the light source 12 from the lamp base 18. The fingers 20 each have a protrusion 58 extending generally laterally towards the insertion axis 22 to be received in the groove 16 of the envelope 14. The protrusion 58 on each finger 20 preferably has ramped surfaces 60, 61 acting as camming surfaces to facilitate the insertion and removal of the light source 12. A portion of the fingers, preferably adjacent the ends 54 of the fingers 20, have a necked down portion 64 to further promote deflection of the fingers 20 during insertion and removal of the light source 12.

Considering the assembly of the lamp envelope 14 into the base 18 in greater detail, the light source 12 is disposed along the insertion axis 22 and toward the lamp base 18 so that at least one finger 20 deflects relative to the insertion axis 22 upon contacting the side wall 30 of the envelope 14. This is shown in FIG. 2. The end 28 and/or side wall 30 of the envelope 14 contacts the ramped surface 60 on each protrusion 58, thus causing the fingers 20 to deflect outwardly from the axis 22. Preferably, the fingers 20 are deflected throughout the necked down portion 64 due to the resulting interference between the envelope 14 and the protrusions 58. The deflection of the fingers 20 preferably results in an elastic deformation of the fingers 20, thus incurring a bias within the fingers 20 to return to their non-deflected position.

As best shown in FIG. 3, upon full insertion of the light source 12 within the lamp base 18, the fingers 20 return at least partially to their non-deflected position as a result of their intrinsic resiliency until the protrusions 58 are fully received within the groove 16 of the lamp envelope 14. The fingers 20, with the protrusions 58 received and engaged in the groove 16, act to inhibit relative movement between the envelope 14 and the lamp base 18. In this way, the lamp 12 is releaseably mounted to the lamp base 18.

Generally, with the light source 12 fully inserted into the lamp base 18, the flat end 28 of the envelope 14 preferably lies within or near a plane established by the base surface 46 of the housing 44. Hence, with the drive circuit 24, shown here as having an energizing coil 66, inserted within the housing 44 of the lamp base 18 to contact against the end of the fingers 20, and thus base surface 46, the flat end of the envelope 14 abuts the energizing coil 66 of the drive circuit 24. This arrangement is particularly advantageous for use with electrodeless gas discharge lamps operated by a coil, since the physical arrangement shown permits the time-varying magnetic field produced by the coil to be closely coupled to the gas within the lamp envelope. The construction of suitable drive circuits and coil topologies for use with lamp 14 and base 18 is known to those skilled in the art.

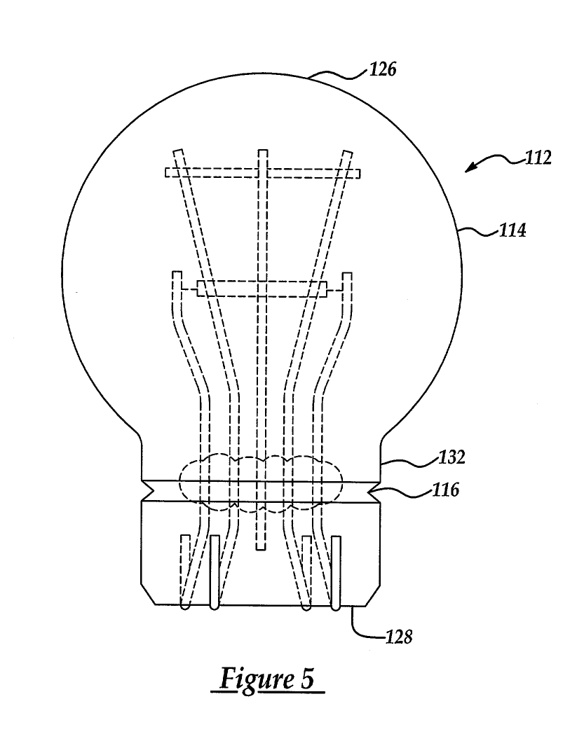

In FIG. 5, a second embodiment of a lamp that can be used as a part of the invention is shown where like numerals are used to indicate like parts, but are offset by 100. The light source 112 having a light-transmissive envelope 114 is shown as a filament style lamp. The base end 128 of the lamp can, but need not be, a press-sealed (flat) end with the groove either formed on the press-sealed portion or circumferentially around a bulbous portion of the lamp envelope 114. The lead wires can be bent back over the outer surface 132 of the lamp as shown, or can extend downward, and in either case can mate with wire traps on the base 18 of FIGS. 1-4. The construction and use of suitable wire traps is known to those skilled in the art. Alternatively, the wires can lead directly to a circuit board or connector in the lamp base 18. The envelope 114 has a groove 116 in the outer surface 132 of the envelope 114 located between a pair of opposite ends 126, 128. The groove 116 is shaped to be received by the fingers 20 of the lamp base 18 as in the first embodiment so that the light source 112 is releasably mounted in the lamp base 18.

In service, the light source 12, 112 may be removed from the lamp base 18 by applying an adequate force to cause the fingers 20 to deflect outwardly, thus removing the protrusion 58 on each finger 20 from the groove 16, 116 of the light-transmissive envelope 14, 114. The removal of the protrusions 58 from the groove 16, 116 is facilitated by the ramped surface 61 on each finger 20. It should be recognized that in the absence of an adequate force, the light source 12, 112 remains releasably mounted within the lamp base 18.

The lamp base can be made from any suitable material, such by plastic using injection molding techniques. In the case of incandescent and other lamps that operate at high lamp envelope temperatures, special high temperature plastics well known in the art can be used.

It should be recognized that the lamp base 18 may be formed otherwise than as shown here, and may be formed having fingers 20 with projections extending radially outwardly to engage a groove 16 formed within an envelope 14 at least partially hollow in form (not shown). A hollow portion of an envelope 14 may have the groove 16 formed in the outer surface of an inner diameter of the hollow portion, such that the groove 16 extends radially outwardly instead of radially inwardly as shown.

It will thus be apparent that there has been provided in accordance with the present invention a lamp assembly which achieves the aims and advantages specified herein. It will of course be understood that the foregoing description is of preferred exemplary embodiments of the invention and that the invention is not limited to the specific embodiments shown. Various changes and modifications will become apparent to those skilled in the art. For example, the lamp base may be formed otherwise than as shown here, and may be formed having fingers with projections extending radially outwardly to engage a groove formed in the wall(s) of a recessed portion of a lamp envelope. The recessed portion of the envelope may have the groove formed in the outer (exposed) surface of the recessed wall(s), with the fingers being biased radially outwardly to engage the groove and retain the envelope in place on the lamp base. All such variations and modifications are intended to come within the scope of the appended claims.

What is claimed is:

1. A lamp assembly, comprising:
a light source that includes a light-transmissive envelope having a groove therein; and
a lamp base having a mounting surface extending about an insertion axis, said mounting surface having at least one finger capable of deflecting relative to said axis to receive said light-transmissive envelope and returning at least partially to be received in said groove thereby inhibiting relative movement between said light-transmissive envelope and said lamp base along said axis.

2. The lamp assembly of claim 1, wherein said light-transmissive envelope has a pair of opposite ends with said groove extending circumferentially about said light-transmissive envelope at an intermediate location between said ends.

3. The lamp assembly of claim 2, wherein said groove is located adjacent one of said ends and remotely from the other of said ends.

4. The lamp assembly of claim 1, wherein said lamp base has a housing portion adjacent said mounting surface for receiving drive circuitry that provides power to said light source.

5. The lamp assembly of claim 4, wherein said housing portion has a base surface providing for a positive stop locator for the drive circuitry.

6. The lamp assembly of claim 5, wherein said at least one finger forms at least part of said base surface.

7. The lamp assembly of claim 5, wherein said light-transmissive envelope has an end extending toward said housing portion wherein said end abuts the drive circuitry when said at least one finger is received in said groove and the drive circuitry is in contact with said base surface of said housing portion.

8. The lamp assembly of claim 7, wherein said light source is a gas discharge lamp and wherein said drive circuitry comprises an energizing coil abutting said end of said gas discharge lamp.

9. The lamp assembly of claim 7, wherein said end is generally flat.

10. The lamp assembly of claim 1, wherein said finger is one of a plurality of said fingers spaced circumferentially around said groove.

11. The lamp assembly of claim 10, wherein each of said fingers includes a protrusion biased into said groove.

12. A lamp assembly, comprising:
a light source that includes a light-transmissive envelope having a groove therein; and
a lamp base having a mounting surface engaging said groove and inhibiting movement of said light-transmissive envelope relative to said lamp base, said lamp base including at least one finger having a protrusion that forms at least a portion of said mounting surface and that extends into said groove with said protrusion being biased into engagement with said groove.

13. The lamp assembly of claim 12, wherein said light-transmissive envelope has a pair of opposite ends with said groove extending circumferentially about said light-transmissive envelope at an intermediate location between said ends.

14. The lamp assembly of claim 13, wherein said groove is located adjacent one of said ends and remotely from the other of said ends.

15. The lamp assembly of claim 12, wherein said lamp base has a housing portion adjacent said mounting surface for receiving drive circuitry that provides power to said light source.

16. The lamp assembly of claim 15, wherein said at least one finger forms at least part of said housing portion.

17. The lamp assembly of claim 15, wherein said housing portion has a base surface providing for a positive stop locator for the drive circuitry.

18. The lamp assembly of claim 15, further comprising the drive circuitry located within said housing portion, wherein said light-transmissive envelope has an end extending toward said housing portion wherein said end abuts said drive circuitry when said at least one finger is received in said groove and said drive circuitry is in contact with said at least one finger.

19. The lamp assembly of claim 18, wherein said light source is a gas discharge lamp and wherein said drive circuitry comprises an energizing coil abutting said end of said gas discharge lamp.

20. The lamp assembly of claim 17, wherein said end is generally flat.

21. The lamp assembly of claim 12, wherein said finger is one of a plurality of said fingers spaced circumferentially around said groove.

22. The lamp assembly of claim 21, wherein each of said fingers includes a protrusion biased into said groove.

23. A lamp assembly, comprising:
a light source that includes a light-transmissive envelope having a groove therein; and
a lamp base having opposite ends with an inner mounting surface defining an opening about an insertion axis adjacent one end, said inner mounting surface having at least one finger with a protrusion extending toward said insertion axis, said at least one finger capable of deflecting outwardly from said insertion axis for receiving said light-transmissive envelope and returning at least partially biasing said protrusion into engagement within said groove to thereby inhibit relative movement between said light-transmissive envelope and said lamp base along said axis.

24. The lamp assembly of claim 23, wherein said light-transmissive envelope has an outer surface defining a first diameter and said groove defining a second diameter wherein said first diameter is greater than said second diameter.

25. The lamp assembly of claim 23, wherein said lamp base has a housing portion adjacent the end opposite said one end for receiving drive circuitry that provides power to said light source.

26. The lamp assembly of claim 25, wherein said at least one finger forms at least part of said housing portion.

27. The lamp assembly of claim 25, wherein said housing portion has a base surface providing for a positive stop locator for the drive circuitry.

28. The lamp assembly of claim 25, further comprising the drive circuitry located within said housing portion, wherein said light-transmissive envelope has an end extending toward said housing portion wherein said end abuts said drive circuitry when said at least one finger is received in said groove and said drive circuitry is in contact with said at least one finger.

29. The lamp assembly of claim 23, wherein a plurality of fingers are circumferentially spaced from one another by an axial slit traversing along said insertion axis wherein said axial slit provides for inward and outward deflection movement of said fingers relative to one another.

30. A method of making a lamp assembly, comprising:
providing a light source having a light-transmissive envelope and a groove therein;
forming a lamp base having a mounting surface extending about an insertion axis and at least one finger having a protrusion wherein said finger forms at least a portion of the mounting surface; and
disposing the light-transmissive envelope along the insertion axis and toward the lamp base so that said at least one finger deflects relative to the insertion axis upon contact with the light-transmissive envelope until said protrusion is received within the groove, wherein said finger is biased to maintain said protrusion in said groove such that the light-transmissive envelope is inhibited from moving axially relative to the lamp base.

31. The method of claim 30, wherein said forming step further comprises forming said lamp base with a plurality of fingers each having a protrusion facing inwardly toward said insertion axis.

32. The method of claim 30, wherein said forming step further comprises molding said lamp base from plastic.
